(19) United States
(12) Patent Application Publication
(10) Pub. No.: US 2007/0119290 A1
(43) Pub. Date: May 31, 2007

(54) System for using audio samples in an audio bank

(76) Inventor: Erik Nomitch, Bannockburn, IL (US)

Correspondence Address: Eric D. Cohen, 22nd Floor, 120 South Riverside Plaza, Chicago, IL, 60606-3945, US

(21) Appl. No.: 11/288,865

(22) Filed: Nov. 29, 2005

(51) Int. Cl. G10H 7/00

(52) U.S. Cl. 84/603

(57) ABSTRACT

A sound performance system configured to control one or more sound generating devices includes at least one audio bank containing digitized audio representing a single note of an instrument. The bank includes a plurality of audio sub-files, where each sub-file corresponds to variations of the single note. Also included is a selector corresponding to each audio bank, where the selector is configured to select one sub-file in the bank in response to a request corresponding to the single note to be played. The selector selects the one sub-file according to predetermined criteria.

### FIELD OF THE INVENTION

The present invention relates generally to an apparatus for the performance of sound and music, and more specifically to a plug-in module containing audio files corresponding to notes to be played for selected instruments.

### BACKGROUND

The digital sampling of acoustic instruments has become a popular practice among amateurs and professionals in the recording and playback of musical instruments. Such techniques are used in home and professional studios as well. The popularity of this process has increased, in part, due to the development and acceptance of the Musical Instrument Digital Standard protocol (MIDI), which is the now the industry standard.

The MIDI protocol has been widely accepted and utilized by musicians and composers since its conception in the early 1980's. MIDI is a very efficient method of representing music and other sound data, and is thus an attractive protocol for computer applications which produce sound, such as digital recording applications, music synthesizers, electronic instruments, computer games, and the like.

MIDI information is transmitted in “MIDI messages,” which are instructions that direct a music synthesizer or other sound output device how to play a piece of music or sequence of sounds. The device receiving the MIDI data generates the actual sounds. (See MIDI 1.0 Detailed Specification, published by the International MIDI Association for a more detailed description.)

There are a number of different technologies capable of creating sounds in music synthesizers. Two widely used techniques are frequency modulation (FM) synthesis and wavetable synthesis. FM synthesis techniques generally use a periodic signal called the carrier, and a modulator signal to modulate the frequency of the carrier. If the modulating signal is in the audible range, then the result will be a change in the timbre of the carrier signal. Each FM output signal, often referred to as the “voice,” requires a minimum of two signal generators, referred to as “operators.” Sophisticated FM systems may use four to six operators per voice, and such operators may have adjustable waveform envelopes, which allow adjustment of the attack and decay of the signal. Although FM systems were implemented in the analog domain on early synthesizer keyboards, modern FM synthesis implementations are performed digitally.¹
¹ courtesy of Jim Heckroth, Tutorial on MIDI and Wavetable Music Synthesis

FM synthesis techniques are very useful for creating synthesized sounds. However, if the goal of the synthesis system is to recreate the sound of an existing instrument, this can generally be done more accurately with digital sample-based techniques. Sampling essentially replicates acoustic instruments electronically by the use of samples. It is essentially a small “snippet” of a digitized audio signal, which is recorded from an acoustic instrument.

Digital sampling systems store sound samples, and then replay these sounds on demand, typically using MIDI commands. Digital sample-based systems may employ a variety of special techniques, such as sample looping, pitch shifting, mathematical interpolation, and polyphonic digital filtering, to reduce the amount of memory required to store the sound samples, or to provide more types of sounds from a given amount of memory. Such sample-based synthesis systems are often called “wavetable” synthesizers. The sound created is the digitized sound of a real instrument, not an electronically synthesized signal. These systems include the sample memory, which contain a large number of sampled sound segments, and can be thought of as a “table” of sound waveforms, which may be accessed as a look-up table and utilized when needed.¹
¹ courtesy of Jim Heckroth, Tutorial on MIDI and Wavetable Music Synthesis

Many benefits are associated with the digital sampling of instruments. Sampling instruments through what is known as a “plug-in” is the most common of these digital recording practices. A plug-in is usually software based, but can also be a hardware chip, such as a ROM or PROM. When using a plug-in, the user's digital sequencer acts as the base for the plug-in. The user can obtain and load a large variety of software plug-ins from the manufacturer of the platform or from third party vendors to perform various tasks, such as equalizer functions, virtual instruments, compressors, and the like.

A sample is an audio file of one hit, a note, or single sound, often referred to as the “voice” of the instrument or object, and used interchangeably herein. Once the user has obtained a sampling plug in, he or she can then load samples from a digital media (sound formats of .wav, .mp3 formats and the like) into the sampling plug-in, or modify the existing digital media, which corresponds to each channel or note of the MIDI controller or map.

The user then connects a MIDI controlled device, such as a keyboard, electronic drum set, and the like, to a computer or controller via a MIDI interface. The MIDI controlled device can then send digital signals to the computer, which are decoded by the computer. The computer decodes notes and dynamic level (loudness) only. When the sample is played, the computer sends the MIDI information either back to the MIDI controlled device capable of playing the sampled sound, or may send the MIDI information to a synthesizer to play the sampled sound. Alternatively, the MIDI information may be scripted in the form of a MIDI track, which can be viewed and manipulated by the user using a sequencer program, which is used to manipulate the MIDI data and organize various tracks of data into a final sound output.

For example, a MIDI compatible drum set may be connected to a MIDI interface. The user can then assign each note (also referred to as a “hit” or drum) on the MIDI drum set to a specified audio sample in the sampling plug-in. When the user then plays a drum on the MIDI drum set, the computer detects the dynamic level and note played, and accesses the file corresponding to that note on the drum set causing the sample to be played at the dynamic level specified by the hit. For each note played, the corresponding sample is accessed. Note that the sample does not inherently include dynamic level or loudness information. The computer assigns a dynamic level to the accessed note based on information provided to it by the MIDI instrument.

When the user assigns an audio sample to each MIDI channel or note using the plug-in, the final product becomes a “faux” instrument that attempts to imitate the sound of a natural instrument. Each note or channel can change in dynamic range, and one audio file per note or channel is played, which is varied only by dynamics based on information provided by the MIDI instrument. There are many benefits to such generated instruments. Even if the user does not own the instrument, for a fraction of the price one can record a “fake” version that sounds comparable to the real instrument. Also, by using a “MIDI map,” the user can create or alter the notes and note placements from the instrument just like a virtual sheet of music.

Electronic playable instruments have also been incorporated into recording productions and live music scenarios. Electronic keyboards and electronic drum sets are the most commonly used electronic instruments. Using a sampling plug-in, an electronic drum set would include one audio file that corresponds to each “note” or hit of each type of percussion instrument. For example, a sampling plug-in would provide for an acoustic bass drum, snare drum, ride bell, cow bell, crash cymbal, splash cymbal and the like. Any percussion instrument could be included, depending upon the complexity and robustness of the system. Such “instruments” when played, however, are varied only by dynamics depending on how hard the player strikes a drum or cymbal, respectively.

One disadvantage of known systems for digital sampling with electronic instruments is that the resulting sound is perceived as mechanical or unnatural because when the same note is repeated, the identical corresponding audio file is repeated. Such repetition of an identical audio files creates an unnatural sound because acoustic instruments played manually will always have slight variations in the sound of each hit for the same note. Thus, natural variations exist in an acoustic instrument even when playing the same note over and over. Many musicians can easily distinguish between a sampled instrument and a real acoustic instrument because of the lack of variation in timbre.

In that regard, if an acoustic drum is struck multiple times, the sound produced will never be exactly the same from hit to hit. In a real instrument, each slight variation in drum stick placement will create a minute differences in the overall sound of the groups of hits. This does not occur in sampled drums or other sampled instruments because the same file is used each and every time. This is particularly apparent to the listener in percussion based sampling systems, such as drums. This phenomenon is particularly apparent if an electronic drum is struck multiple times in a relatively short amount of time. In this case, even an untrained human ear can distinguish the use of a single audio file and, therefore may recognize the sound as electronically produced.

### SUMMARY

The disadvantages of present audio sampling systems may be substantially overcome by providing a novel MIDI based sampling system having sampling plug-ins with multiple samples accessed for a single note of a selected instrument. Instead of accessing one audio sample for each note played, the sampling plug-in or electronic instrument selects a sub-file from a bank of similar but non-identical audio sub-files, where each sub-file is generally related to each MIDI note, but with variation. This can be done randomly or in accordance with other suitable selection formats.

More specifically, in one embodiment, a sound performance system is configured to control one or more sound generating devices, and includes at least one audio bank containing digitized audio representing a single note of an instrument. The bank includes a plurality of audio sub-files, where each sub-file corresponds to variations of the single note. Also included is a selector corresponding to each audio bank, where the selector is configured to select one sub-file in the bank in response to a request corresponding to the single note to be played. The selector selects the one sub-file according to predetermined criteria.

The system may include a random number generator operatively coupled to the selector to provide the predetermined criteria in selecting the sub-file, where the predetermined criteria is a random selection. After a sub-file has been selected according to the random criteria, that sub-file may be excluded from further selection until some or all of the sub-files in the bank have been selected. Alternatively, the predetermined criteria may be in accordance with a forward or backward sequential or linear selection.

Also, a sub-file tracker may be included to track when sub-files have been selected. The file tracker may mark a sub-file as used when a first access of that sub-file occurs, and may disable selection of that sub-file when a second access of that sub-file is attempted if unused sub-files exist in the selected bank. The file tracker may also mark all sub-files in a bank as unused after all sub-files in a bank have been accessed.

### BRIEF DESCRIPTION OF THE DRAWINGS

The features of the present invention which are believed to be novel are set forth with particularity in the appended claims. The invention, together with further objects and advantages thereof, may best be understood by reference to the following description in conjunction with the accompanying drawings.

FIGS. 1-2 are block diagrams of known audio environments or platforms in which the present invention may be implemented;

FIG. 3 is a specific embodiment showing a block diagram of an audio environment or platform accordingly to the present invention; and

FIG. 4 is a specific embodiment of a block diagram of a sampling plug-in according to the present invention.

### DETAILED DESCRIPTION

In this written description, the use of the disjunctive is intended to include the conjunctive. The use of definite or indefinite articles is not intended to indicate cardinality. In particular, a reference to “the” object or thing or “an” object or “a” thing is intended to also describe a plurality of such objects or things.

Note that in the illustrated embodiments, the system or platform shown is based on the MIDI standard, which is currently the industry standard, and represents the environment of the preferred embodiments. However, the present invention is not limited to use with a MIDI standard and may be used in any suitable environment that supports sampled audio. The present invention contemplates use with future standards without departing from the scope and spirit of the present invention.

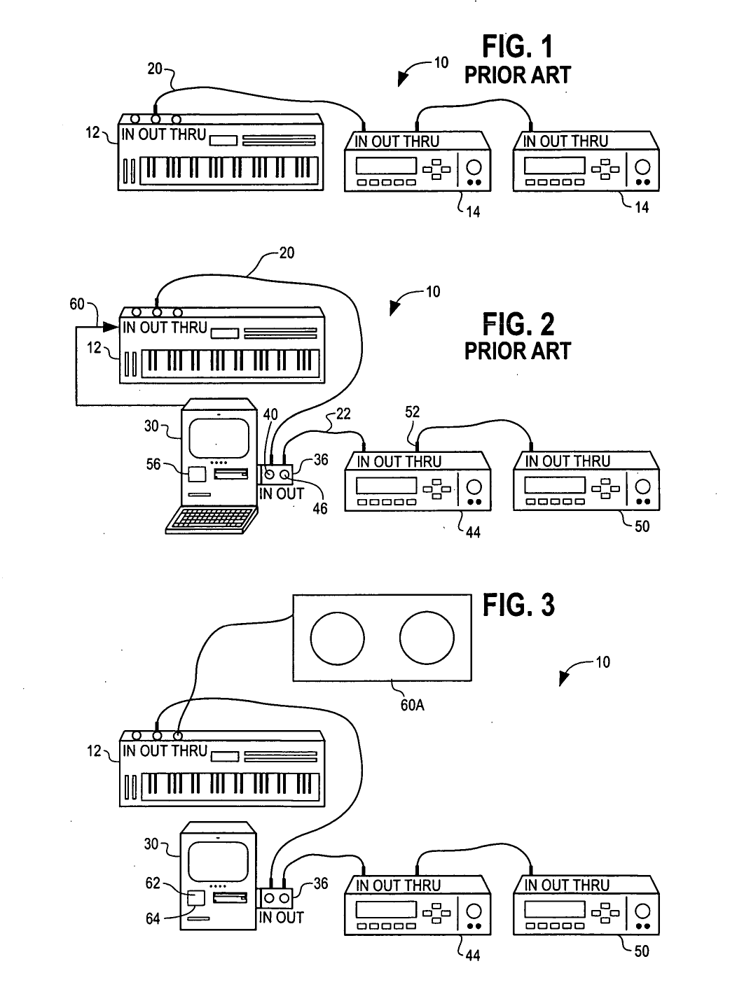

Referring now to FIGS. 1 and 2, known audio environments or platforms 10 are shown. FIG. 1 shows a MIDI keyboard instrument 12, referred to as the master, linked to several slave devices, such as synthesizers 14. Typically, the slave devices or synthesizers 14 are multi-timbral, meaning they can play or output different instruments simultaneously. According to the MIDI standard, each MIDI device includes an “IN,” “OUT,” and “THRU” port. The IN port responds to incoming MIDI signals 20, the OUT port transmits MIDI performance information 22, and the THRU port merely passes the MIDI performance information from one device to the other. In this arrangement, the keyboard instrument 12 may include a MIDI controller (not shown). This configuration of FIGS. 1-2 illustrates a MIDI chain. The MIDI keyboard 12 may also include its own sound generator or synthesizer, which may be played in “local” mode without need for the slave synthesizer devices 14.

FIG. 2 illustrates a more versatile platform, which includes a computer (PC) 30 with a MIDI interface device or card 36, the keyboard 12, and two slave devices. Like reference numerals are used to show like structures or devices. The MIDI keyboard or controller 12 is used as an input device to a MIDI IN port 40 of the MIDI interface device 36. Note although hardware that is coupled to the computer is generally referred to as a “card,” such devices may be stand-along devices and need not be in the physical form of a “card.” As shown, a first sound device or synthesizer 44 may be connected to a MIDI OUT port 46 of the interface card 36, while a second device or synthesizer 50 may be connected to the MIDI THRU port 52 of the first sound device. The MIDI interface card 36, in turn, may provide data to a MIDI sequencer 56 (shown in block form in FIG. 2), which may be a software sequencer program running on the computer 30. The sequencer application software 56 may be a commercially available software package, such as, Pro Tools Version 5.0.1 by Digidesign Co., Digital Performer Version 4.5 by Mark Of The Unicorn Corp., Cubase Version SX-3 by Steinberg Corp., and the like. Such software applications are capable sequencing and recording music and sounds, and may also provide music scoring, games, and the like.

Alternatively, the slave devices 14, 44, 50 may be omitted such that the MIDI messages may be sent back from the MIDI interface card 36 to the MIDI keyboard/controller 12 along a path labeled as 60, assuming that the MIDI keyboard/controller 12 has the capability to play back the desired “voices.” Preferably, the MIDI keyboard/controller 12 in local mode is multi-timbral.

Alternatively, no sound generation device need be present, as the sequencer 56 may create a “MIDI track” which essentially stores the MIDI commands that would eventually be sent to the sound output devices. The user can manipulate the sound or music as shown on a computer screen, and may even score an entire musical composition.

Preferably, in the above-described known platform 10, all cards or other hardware coupled to the computer 30 and all software installed conform to the Roland MPU-401 interface standard, which is the industry standard for a “smart” MIDI interface. Any suitable computer may be used, such as an IBM compatible personal computer, computers conforming to the Microsoft Multimedia PC (MPC) standard, Linux operating systems, Macintosh computers and operating systems by Apple Computer, and other compliant computers, computer cards, and operating systems.

According to the MIDI standard, each single physical MIDI channel is divided into 16 logical channels, which is designated by a four bit channel number within selected MIDI data messages. For example, the particular musical instrument, such as the keyboard 12 shown, can generally be set to transmit on any one of the sixteen MIDI channels. The first and second sound devices 44, 50 can be set to receive on designated MIDI channel(s).

This environment or platform 10 is very versatile and is often used to compose and produce music having multiple parts. A user may compose a piece of music where each part is written for a different instrument. The user may play each of the individual parts separately on the keyboard 12, and each of these parts would be captured by the sequencer 56, which would then play the parts back simultaneous through the sound devices 44, 50. Each part would be played on a different MIDI channel, and the sound devices would typically be set to receive different channels. For example, the first sound device 44 may be set to play “violins” on MIDI channel 1 using the keyboard, while the second device 50 may be set to play “trumpet” on MIDI channel 2, again played by the keyboard.

FIG. 3 shows a system or platform similar to FIG. 2 but additionally (or instead of) includes a drum machine 60, which could be set, for example, to transmit MIDI data on MIDI channel 3. A MIDI sequencing software 62 program may execute on the computer 30, which may be of a type similar to the sequencing program 56 of FIG. 2. The sequencing program 62 may be completely software based or exist as a mix of hardware and software. It may reside completely in the computer 30, or may be incorporated into other suitable hardware.

The sequencer 62 is preferably adaptable or customizable through the addition of various plug-ins, which themselves can be customized. As mentioned above, sounds can be created using synthesis (FM modulation) or wavetable synthesis. However, sampling techniques using wavetable synthesis result in the production of more realistic sounds. One class of sounds particularly suited for wavetable synthesis are known as “one-shot” sounds and are characterized by having a short duration or whose characteristics change dynamically throughout their duration. Short drum sounds are one such category of one-shot sounds. Typically, the entire sound for the entire note is contained in an audio file since its duration is relatively short. No looping or interpolation is typically performed or needed.

The term “note” may be used interchangeably for the term “hit.” Generally, the term “note” may be more applicable when referring to instruments having separate playable notes, as even non-musicians would understand the term, such as a keyboard. The term “hit” may be more intuitive when referring to percussion instruments, especially drums, because a drum “hit” conveys that actually occurs with an acoustic drum.

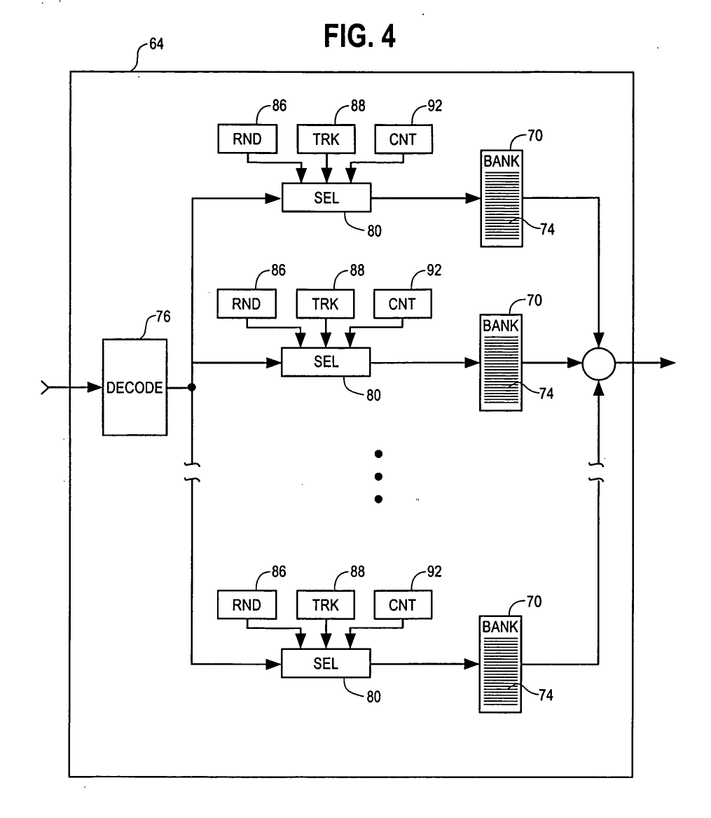

Referring now to FIGS. 3-4, FIG. 4 a simplified block diagram of a plug-in for use with the sequencing software program 62 of FIG. 3. This can also be implemented in hardware or in a mix of hardware and software. As mentioned above, a plug-in software module 64 or modules may be utilized by the sequencer software and/or hardware 62. The audio files contained in the plug-in may be in the form of “.wav” or “.MP3” compatible files. Any suitable file format may be used. These are often referred to as “patches.”

Commercially available plug-ins and programs to modify such plug-ins may be used, such as Battery Studio Drums from Native Instruments Corp. Such plug-ins 64 are commercially available, and are quite flexible and permit wide range of customizable options, depending on the type selected. For example, free plug-ins are available on the Internet, but they are usually very limited, and only provide for dynamic level variations and may only contain a limited number of “slots” which correspond to the particular audio file for each note.

More robust plug-ins provide a sophisticated framework in which to manipulate the various audio files and insert within the plug-in certain decision-making logic or software to control how to select the various audio files and under what criteria. Note that such decision-making software regarding how the audio files in the plug-in are selected preferably reside in the plug-in, however, the location of such code is not particularly important, and such logic may reside in any suitable module, software program, or hardware implementation without departing from the scope and spirit of this invention. It is only industry convention that dictates the most cost-effective approach. For example, it is possible that a particular sequencer program would not utilize separate plug-ins, but rather, would incorporate an internal mechanism to access internal audio files to accomplish the same purpose. Of course, there are advantages to following the industry standard.

One suitable commercially available plug-in 64 with “wavetable” ability that may be utilized in this invention is the Tascam Gigastudio 3.1 plug-in. Such a robust plug-in provides the basic framework used to manipulate the audio files in the plug-in.

As set forth above, one significant drawback of known systems is that the plug-in provides one file for one particular drum note or hit, and thus each time the note is struck, the same file is accessed, which results in an unnatural sound when many of the same notes or hits are played in sequence. Also note that for many drums, only a single note or hit exists, although some snare drums, for example, may be represented by two or three different notes or hits, such as drum hit, drum click and the like. Cymbals for example, are often represented by five or six notes or hits, especially the high-hat, which would have a separate note for open, close, pedal hit, and the like.

In known plug-ins, such “short duration” sounds, like drums, can usually be provided in a wavetable-type application using a small number of audio files, that is, one audio file per note or hit. For some percussion instruments, although there may only be one note or hit, it is sometimes preferred to have multiple notes or hits represented nonetheless, where one note or hit may be “played” at one dynamic level and another note may be played at a second dynamic level. This may be preferably with percussion instruments where the real characteristics or timbre of the note changes significantly when played softly compare to when it is played loudly. Such an instrument can be considered to be represented by two notes or hits in this case.

In a specific preferred embodiment in accordance with the present invention, the plug-in or module 64 is configured to contain multiple banks 70, where each bank corresponds to a particular note or hit of the instrument. The number of banks is preferably equal to the number of notes or hits provided for that instrument. The banks contain audio data files.

Further, each bank may contain multiple sub-files 74, where each of the sub-files also generally corresponds to the particular hit or note, but with variation. Although each sub-file in the bank corresponds to the same basic note or hit, each sub-file has subtle differences because each sub-file was created from a real drum note produced on a real acoustic instrument. Such real-life playing of an acoustic instrument results in very slight differences from played note to played note or hit-to-hit, even if the same note or hit is played as the same dynamic level. This is the human factor.

Each time a note is played or a hit is struck via a MIDI controller, such as the electronic drum set 60, keyboard, etc. or from a MIDI map, a decoder 76 decodes the note and determines which of the bank selectors 80 to access. A MIDI map may be thought of as a MIDI track that can be modified and edited. Preferably, there is one bank selector 80 for each bank 70. The particular bank selector accessed then may select one of the audio sub-files 74 in the specified bank 70 in accordance with predetermined or programmed criteria. The selected sub-file 74 may then be output to the sequencer 62 for use. For example, if a snare drum is represented by three notes, there may be three bank selectors 80 and three banks 74 of sub-files, where each sub-file in the bank would correspond, with subtle differences, to the selected note or hit. Any known selection means or selector may be used, as is known to one of skill in the art, such as comparison based selector and the like.

The subtle differences between the audio sub-files are due to human quality associated with the actual playing of a physical instrument, which sound differences are represented by the digitized audio sounds of the human drummer captured in the plug-in. When played on the output device 44, 50, the human ear will be “fooled” into believing that the instrument is “real” and such audio reproduction will sound almost identical to a real acoustic instrument because of the slight variations in the audio sub-files.

The number of audio sub-files 74 in the bank 70 corresponding to one note of a particular instrument is preferably about ten, and may range, for example, between two and twenty. More than ten or twenty sub-files may be used, and any reasonable number of sub-files per note may be used within the constraints of cost and memory. Using ten sub-files 74 per note or hit, for example, provides a reasonably large sample of sub-files and thus accessing of such sub-files provides a relatively wide variation, resulting in a more natural reproduced sound. Numbers of sub-files 74 per note or hit exceeding twenty, for example, do not appear to produce a worthwhile incremental benefit.

In one embodiment, each time a particular note is played or hit occurs corresponding to a particular bank 70, an audio sub-file 74 may be selected, where the audio sub-file may be selected and played randomly. Each time the note or hit is played, the corresponding sub-file 74 may be accessed randomly. A random number generator 86 operatively coupled to the selector 80 may provide the selection criteria.

In another embodiment, to avoid inadvertent repetition of a sound file during the randomization, a file tracker 88 operatively coupled to the bank selector 80 may “mark” that the selected sub-file has been used, and may exclude that sub-file from being selected again until all or most of the sub-files in the bank 70 have be used or selected in subsequent accesses. Once some or all of the sub-files 74 in the bank 70 have been accessed, they are marked as “available,” such that all of the sub-files in that bank are then available for subsequent access.

In another embodiment, each sub-file 74 may be accessed sequentially, either from first to last or last to first in a looping manner. A counter 92 may be operatively coupled to the selector 80 may be used to loop through the available sub-files 74. Any suitable method may be used to access the audio sub-files 74 so that subtle variants of the played notes are reproduced.

The result according to the present invention is a convincing, natural sound for any instrument using wavetable techniques, and is particularly advantageous when used with percussion instruments. This significantly overcomes the perceived mechanical characteristic of digitally reproduced music of known systems using sampling. The present invention combines the advantages of generating realistic sounds of an acoustic instruments with the ease of computer based MIDI mapping and electronic instruments.

Specific embodiments of a system for using audio samples in an audio bank according to the present invention have been described for the purpose of illustrating the manner in which the invention may be made and used. It should be understood that implementation of other variations and modifications of the invention and its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

What is claimed is:

1. A sound performance system configured to control one or more sound generating devices, the sound performance system comprising:
at least one audio bank containing digitized audio sound;
the bank including a plurality of audio sub-files;
a selector corresponding to each audio bank;
the selector configured to select one sub-file in the bank in response to a request corresponding to the single note to be played; and
wherein the selector selects the one sub-file according to predetermined criteria.

2. The sound performance system according to claim 1, further including a random number generator operatively coupled to the selector to provide the predetermined criteria in selecting the sub-file.

3. The sound performance system according to claim 1, wherein the predetermined criteria is a random selection.

4. The sound performance system according to claim 3, wherein after a sub-file has been selected according to the random criteria, that sub-file is excluded from further selection until some or all of the sub-files in the bank have been selected.

5. The sound performance system according to claim 1, wherein the predetermined criteria is a forward or backward sequential selection.

6. The sound performance system according to claim 1, further including a sub-file tracker configured to track when sub-files have been selected.

7. The sound performance system according to claim 6, wherein the file tracker marks a sub-file as used when a first access of that sub-file occurs.

8. The sound performance system according to claim 7, wherein the file tracker disables selection of a sub-file when a second access of that sub-file is attempted if unused sub-files exist in the selected bank.

9. The sound performance system according to claim 8, wherein the file tracker marks all sub-files in a bank as unused after all sub-files in a bank have been accessed.

10. The sound performance system according to claim 1, wherein each bank contains about ten sub-files.

11. The sound performance system according to claim 1, wherein each bank contains between two and twenty sub-files.

12. The sound performance system according to claim 1, wherein each bank contains more than ten sub-files.

13. A plug-in module for a sound performance system configured to control one or more sound generating devices, the plug-in module comprising:
a bank having a plurality of digitized audio sub-files;
each bank corresponding to a single note of an instrument;
each audio sub-files representing a variation of the single note;
a sub-file selector configured to select one sub-file in the bank in response to a request corresponding to the single note to be played; and
wherein the selector selects the one sub-file according to a predetermined criteria.

14. The sound performance system according to claim 13, further including a random number generator operatively coupled to the selector to provide the predetermined criteria in selecting the sub-file.

15. The sound performance system according to claim 13, wherein the predetermined criteria is a random selection.

16. The sound performance system according to claim 15, wherein after a sub-file has been selected according to the random criteria, that sub-file is excluded from further selection until all of the sub-files in the bank have been selected.

17. The sound performance system according to claim 13, wherein each bank contains between two and twenty sub-files.

18. The sound performance system according to claim 13, further including a sub-file tracker configured to track when sub-files have been selected.

19. The sound performance system according to claim 18, wherein the file tracker marks a sub-file as used when a first access of that sub-file occurs.

20. A sound performance system configured to control one or more sound generating devices, the sound performance device comprising:
at least one bank containing a plurality of digitized audio sub-files;
means for selecting a sub-file in the bank in response to a request corresponding to the single note to be played; and
wherein the means for selection selects the one sub-file according to predetermined criteria.
